(19) United States
(12) Patent Application Publication
(10) Pub. No.: US 2015/0323937 A1
(43) Pub. Date: Nov. 12, 2015

(54) FLUID CONTROL SYSTEM, FLUID DEVICE, AND FLUID CONTROL METHOD

(71) Applicant: CANON KABUSHIKI KAISHA, Tokyo (JP)

(72) Inventor: Yoichi Murakami, Newport News, VA (US)

(21) Appl. No.: 14/705,760

(22) Filed: May 6, 2015

(30) Foreign Application Priority Data
May 9, 2014 (JP) 2014-097769

(51) Int. Cl. G05D 7/06; G01N 35/00

(52) U.S. Cl. CPC G05D 7/0694; G01N 35/00584

(57) ABSTRACT

A fluid control system includes a fluid device including a flow channel including a reaction part in which a first fluid is subjected to a reaction, and a position control apparatus. The position control apparatus includes a position information acquisition unit that acquires information of a position of an interface between the first fluid and a second fluid in the flow channel or between the second fluid and a third fluid in the flow channel. The position control apparatus controls the position of the first fluid in the flow channel based on the information of the position acquired by the position information acquisition unit. The information of the position by the position information acquisition unit is acquired in an interface detection part located upstream or downstream with respect to the reaction part and having a smaller average cross section than in the reaction part.

### BACKGROUND

1. Field of the Invention

The present disclosure relates to a fluid control system, and more particularly, to a fluid control system capable of controlling a position of a fluid in a fluid device.

2. Description of the Related Art

In recent years, intensive research and development has been performed on a technique called micro-total analysis system (μ-TAS) in which all elements necessary in chemical analysis or biochemical analysis are provided on a single chip.

In particular, a microfluidic device for use in genetic diagnosis has been receiving much attention, and a research activity on it has been active.

The genetic diagnosis includes following two steps: amplifying a particular target part of genetic information described in DNA; and detecting the amplified DNA.

U.S. Patent Application Publication No. 2012/0058460 (for simplicity, hereinafter, referred to as PTL 1) discloses a technique of amplifying DNA using a microfluidic device including a plurality of flow channels. In the technique disclosed in PTL 1, one reaction part for amplifying DNA is disposed in each flow channel, and DNA is amplified while controlling the temperature of the inside of the reaction part using a temperature control unit.

To efficiently amplify DNA, it is necessary to accurately control the temperature of a fluid containing the DNA. To achieve this, in a case where DNA is amplified in a fluid device such as that disclosed in PTL 1, it is necessary to accurately control the position of the fluid in the flow channel.

Therefore, in PTL 1, a position of an interface between a fluid subjected to a reaction and another fluid in contact with the former fluid is detected in an interface detection part disposed at an upstream or downstream position with respect to a reaction part, and the position of the fluid is controlled based on the information of the detected position of the interface.

When the position of the fluid is controlled based on the information of the position of the interface formed between the fluids, the control accuracy of the position of the fluid is limited by the resolution of a sensor used to detect the position of the interface. Therefore, in the technique disclosed in PTL 1, when the resolution of the sensor is low, there is a possibility that it is difficult to achieve sufficiently high control accuracy of the position of the fluid.

### SUMMARY

Disclosed herein is a fluid control system including a fluid device including a flow channel having a reaction part in which a first fluid is to be subjected to a reaction, and a position control apparatus, wherein the position control apparatus includes a position information acquisition unit configured to acquire information of a position, in the flow channel, of an interface formed between the first fluid and a second fluid in contact with each other in the flow channel or between the second fluid and a third fluid in contact with each other in the flow channel, the position control apparatus controls the position of the first fluid in the flow channel based on the information of the position acquired by the position information acquisition unit, and the information of the position by the position information acquisition unit is acquired in an interface detection part that is located at an upstream or downstream position in the direction along the flow channel with respect to the reaction part and that has a smaller average area of the cross section perpendicular to the direction along the flow channel than the average area of the cross section perpendicular to the direction along the flow channel in the reaction part.

Further features of the present invention will become apparent from the following description of exemplary embodiments with reference to the attached drawings.

### BRIEF DESCRIPTION OF THE DRAWINGS

FIG. 1 is a diagram illustrating a configuration of a fluid control system according to an embodiment.

FIG. 2A is a diagram schematically illustrating an interface formed between two different fluids in a micro flow channel, and FIG. 2B is a diagram illustrating a concept of a method of determining a position of an interface.

FIGS. 3A to 3C are diagrams illustrating a concept of a method of controlling a position of an interface in an interface detection part.

FIG. 4A is a diagram conceptually illustrating a change in position of a fluid in a reaction part and an interface detection part of a comparative example, FIGS. 4B and 4C are diagrams illustrating cross sections of a flow channel of the comparative example, FIG. 4D is a diagram conceptually illustrating a change in position of a fluid in a reaction part and an interface detection part according to an embodiment, FIGS. 4E and 4F are diagrams illustrating cross sections of a flow channel according to the embodiment.

FIG. 5 is a diagram illustrating a configuration of a fluid control system of a comparative example.

FIG. 6 is a diagram illustrating a configuration of a fluid control system of a first example.

FIG. 7 is a diagram illustrating a configuration of a fluid control system of a second example.

### DESCRIPTION OF THE EMBODIMENTS

Embodiments of the present disclosure are described below referring, as required, to drawings.

### Embodiments

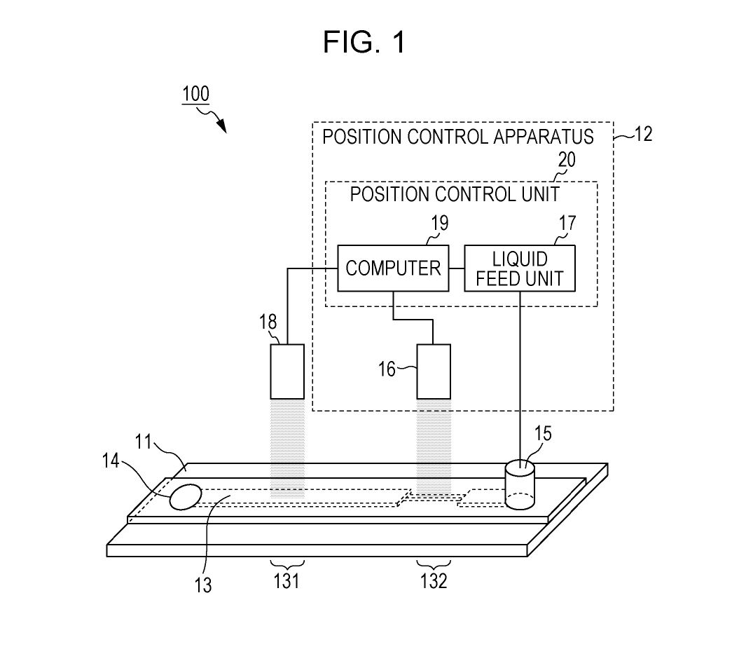

FIG. 1 is a diagram illustrating a configuration of a fluid control system according to an embodiment. As illustrated in FIG. 1, a fluid control system 100 (hereinafter also referred to simply as a system 100) includes a microfluidic device 11 (hereinafter also referred to simply as a device 11) and a position control apparatus 12.

The device 11 includes a micro flow channel 13 (hereinafter also referred to as a flow channel 13), an injection port 14, and a discharge port 15.

The flow channel 13 is a micro flow chart that allows a fluid to flow through the inside thereof. There is no particular restriction on the shape and the size of the flow channel 13.

The flow channel 13 includes a reaction part 131 in which the fluid injected into the flow channel 13 is subjected to a reaction, and an interface detection part 132 that controls a movement of the fluid. The reaction part 131 and the interface detection part 132 are disposed in series in a direction in which the fluid flows in the flow channel 13 (hereinafter, such a direction also referred to simply as a channel direction). That is, the interface detection part 132 is located at an upstream or downstream position with respect to the reaction part 131. In the present embodiment, the interface detection part 132 is located at a downstream position with respect to the reaction part 131.

In a case where the device 11 includes a plurality of flow channels 13, one interface detection part 132 is disposed at an upstream or downstream position with respect to a corresponding reaction part 131 in each flow channel 13. Note that a plurality of flow channels may be a mixture of flow channels in some of which the interface detection part 132 is located at an upstream position with respect to the reaction part 131, and in other of which the interface detection part 132 is located at a downstream position with respect to the reaction part 131. Alternatively, the interface detection part 132 may be located at an upstream position with respect to the reaction part 131 in all flow channels or the interface detection part 132 may be located at a downstream position with respect to the reaction part 131 in all flow channels.

The injection port 14 is a port for injecting a fluid into the flow channel 13. The discharge port 15 is a port for discharging the fluid out of the flow channel 13. That is, the fluid flows into the device 11 through the injection port 14, flows in the flow channel 13, and flows out of the device 11 through the discharge port 15.

The flow channel 13 may be a single flow channel connecting the injection port 14 to the discharge port 15 or may include a branch such that a plurality of ports (including the injection port 14 and the discharge port 15) are connected. In the device 11, a port such as the injection port 14 or the discharge port 15 may be disposed at a position other than ends of the flow channel 13. The device 11 may include a plurality of ports (such as the injection port 14 and the discharge port 15). The device 11 may include a plurality of flow channels 13.

The device 11 may be formed of a transparent material. This makes it possible to optically observe the fluid existing in the flow channel 13. The material of the device 11 may be, for example, glass such as quartz glass, plastic such as acrylic resin or polycarbonate resin, or the like.

The position control apparatus 12 includes a position control unit 20 and a position information acquisition unit 16 (hereinafter, also referred to as an acquisition unit 16).

The position control unit 20 is a unit that controls the position of the fluid in the flow channel 13. The position control unit 20 includes a liquid feed unit 17 and a computer 19.

The liquid feed unit 17 may be, for example, a pressure controller such as a peristalic pump, a syringe pump, or the like. The liquid feed unit 17 is connected to the computer 19. The computer 19 controls the liquid feed unit 17 to change the pressure of the liquid feed unit 17. For example, by reducing the pressure of the liquid feed unit 17, it is possible to move the fluid in the flow channel 13 toward the discharge port 15 connected to the liquid feed unit 17. Conversely, by increasing the pressure of the liquid feed unit 17, it is possible to move the fluid in the flow channel 13 toward the injection port 14.

Although in the present embodiment, the position control unit 20 is connected to the discharge port 15 located downstream of the flow channel 13, the position control unit 20 may be connected to the injection port 14 located upstream of the flow channel 13.

The reaction part 131 is a part of the flow channel 13 where the fluid existing in the reaction part 131 is subjected to a reaction by controlling the temperature of the fluid using a heating element (not illustrated) such as a heater or the like disposed below the flow channel 13.

The system 100 may further include a reaction detection unit 18. The reaction detection unit 18 is a unit that detects light from the fluid existing in the reaction part 131. By detecting light by the reaction detection unit 18, it is possible to detect a change in the fluid caused by the reaction in the reaction part 131.

The reaction detection unit 18 may be configured to receive light one-dimensionally or two-dimensionally from the fluid existing in the reaction part 131. The reaction detection unit 18 transmits a signal depending on the received light to the computer 19 connected to the reaction detection unit 18.

Based on the signal received from the reaction detection unit 18, the computer 19 acquires information associated with the light from the fluid existing in the reaction part 131. The computer 19 may generate image data based on the one-dimensional or two-dimensional signal received from the reaction detection unit 18.

In the system 100, the information of the light from the fluid is acquired by the reaction detection unit 18 and the computer 19 while subjecting the fluid to the reaction in the reaction part 131. Thus, the system 100 is capable of detecting a change in light from the fluid. The reaction of the fluid in the reaction part 131 causes a change in light emitted from the fluid. Thus, by detecting the change in light, it is possible to detect the change in the fluid in the reaction part 131.

In the case where the computer 19 generates image data based on the signal from the reaction detection unit 18, the change in light from the fluid may be detected by the computer 19 by analyzing the image data.

On the other hand, in the case where light from the fluid is detected by the reaction detection unit 18, the fluid existing in the reaction part 131 may be illuminated with light emitted from a light illumination unit (not illustrated) provided for use in the reaction part thereby making the fluid emit light.

A volume expansion occurs in the fluid in the flow channel 13 in response to a change in temperature during the reaction in the reaction part 131 or a difference in temperature with respect to a surrounding environment. As a result, the reaction in the reaction part 131 causes a change in the position of the fluid in flow channel 13. This change in the position of the fluid in the flow channel 13 brings about a change in the position of the fluid existing in the reaction part 131, which is a part of the fluid existing in the flow channel 13. This may make it impossible to continue the reaction of the fluid of interest in the reaction part 131. To handle the above situation, it may be advantageous to control the position of the fluid in the flow channel 13 such that the fluid in the reaction part 131 is kept within the reaction part 131.

In the system 100 according to the present embodiment, to handle the above situation, the position control apparatus 12 controls the position of the fluid in the flow channel 13 during the reaction.

The acquisition unit 16 is a unit that acquires information of the position of an interface 31 formed when two different fluids are brought into contact with each other in the interface detection part 132. The acquisition unit 16, as with the reaction detection unit 18, receives light from the fluid and outputs a signal. The acquisition unit 16 performs analysis using a processing unit (not illustrated) in the acquisition unit 16 or by the computer 19 to acquire information of the position of the interface 31.

In the present embodiment, an optical sensor or the like is used as the acquisition unit 16 to sense light and output a signal corresponding to the sensed light thereby acquiring the information of the position of the interface 31. Note that the acquisition unit 16 is not limited to the unit that optically acquiring the information of the position of the interface 31. For example, the acquisition unit 16 may be a unit configured to electrically acquire the information of the position of the interface 31. However, as for the acquisition unit 16, use of the unit configured to optically acquire the information of the position of the interface 31 may be advantageous in that it is allowed to acquire the information of the position of the interface 31 without direct connection with the fluid of interest in the flow channel 13. By optically acquiring the information of the position of the interface 31 without direct connection with the fluid, it becomes possible to reduce contamination or damage to the fluid.

It may be advantageous to configure the acquisition unit 16 such that light from the fluid existing in the interface detection part 132 is sensed one-dimensionally or two-dimensionally along the channel direction. Furthermore, it may be advantageous to generate image data based on the one-dimensional or two-dimensional signal. By generating the image data in the above-described manner and then analyzing the image data by the computer 19, it becomes possible to acquire the information of the position of the interface 31 and, at the same time, easily acquire a deviation of the position from a target position described below.

Based on the information of the position of the interface 31 acquired by the acquisition unit 16, the position control apparatus 12 controls the position of a first fluid in the reaction part 131. In this process, based on the detected deviation of the interface 31 from the target position, it may be advantageous to control the position of the first fluid in the reaction part 131 so as to reduce the above-described deviation.

In the present embodiment, to detect light from the fluid existing in the interface detection part 132 and light from the fluid existing in the reaction part 131, separate detection units (the acquisition unit 16 and the reaction detection unit 18) are provided. Alternatively, instead of providing two separate detection units, a single detection unit may be provided to detect light. That is, the light from the fluid existing in the interface detection part 132 and the light from the fluid existing in the reaction part 131 may be collectively detected. That is, for example, a detection unit that detects the interface 31 in the interface detection part 132 may also perform the detection in the reaction part 131. This makes it possible to reduce cost and the size of the system 100 compared with the case in which a plurality of detection units are provided.

The acquisition unit 16 may be, for example, a digital camera or the like capable of two-dimensionally detecting light. Note that the acquisition unit 16 is not limited to the digital camera or the like, but other types of units may be employed as long as the units are capable of detecting light at least one-dimensionally along the channel direction of the flow channel 13. That is, the acquisition unit 16 may be an area sensor including a two-dimensional array of photosensors, or a line sensor including an one-dimensional array of photosensors.

Next, a method of forming the interface 31 in the flow channel 13 and a method of determining the position of the interface 31 are described below.

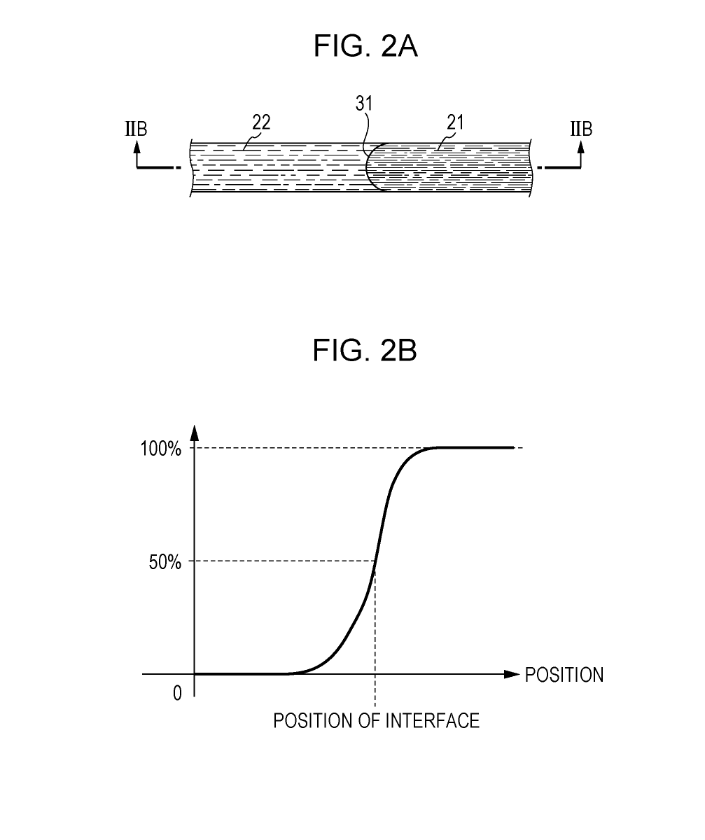

FIG. 2A is a diagram illustrating a manner in which the interface 31 is formed in the flow channel 13 between two fluids, and FIG. 2B is a diagram illustrating a method of determining the position of the interface 31. In FIG. 2A, only a part of the flow channel 13 is schematically illustrated. The injection port 14 is located to the left of the figure, while the discharge port 15 is located to the right of the figure.

First, a second fluid 21, which is different from a fluid to be subjected to the reaction, is introduced into the flow channel 13 via the injection port 14 such that the inside of the flow channel 13 is filled with the second fluid 21. Subsequently, a first fluid 22, which is the fluid to be subjected to the reaction in the reaction part 131 (see FIG. 1), is introduced into the flow channel 13 via the injection port 14. As a result, an interface 31 is formed between the first fluid 22 and the second fluid 21 such that the first fluid 22 and the second fluid 21 are in contact with each other at the interface 31. In the present embodiment, the interface 31 formed in the above-described manner is used as a marker for controlling the position of the first fluid 22 in the flow channel 13.

In the example illustrated in FIG. 2A in which the position of the interface 31 formed between the two fluids is acquired in the interface detection part 132 (see FIG. 1), one of the two fluids is the first fluid 22 to be subjected to the reaction in the reaction part 131 (see FIG. 1). However, the two fluids forming the interface 31 may both be different from a fluid to be subjected to the reaction. That is, the acquisition unit 16 may acquire the information of the position of the interface 31 that is formed when the first fluid 22 and the second fluid 21 are brought into contact with each other, or the acquisition unit 16 may acquire the information of the position of an interface (not illustrated) formed between the second fluid 21 and a third fluid (not illustrated).

For example, the second fluid, the third fluid, and the first fluid may be introduced in this order into the flow channel 13 via the injection port 14, and an interface formed between the second fluid and the third fluid in contact with each other may be used as a marker for controlling the position of the first fluid in the reaction part 131.

Alternatively, the second fluid, the first fluid, the second fluid, and the first fluid may be introduced in this order into the flow channel 13 such that the second fluid and the first fluid are located alternately. In this case, an interface formed between the downstream one of the second fluids and the downstream one of the first fluids in contact with each other may be used as a marker for controlling the position of the upstream one of the first fluids in the micro flow channel.

To determine the position of the interface 31 formed between two different fluids in contact with each other, the acquisition unit 16 performs image processing on the image data acquired from the interface detection part 132.

More specifically, for example, the acquisition unit 16 extracts one-dimensional data of a center part (denoted by line IIB-IIB in FIG. 2A) of the flow channel 13 from the two-dimensional image data acquired in the interface detection part 132. As a result, a luminance profile of particular light is extracted by the acquisition unit 16. Using this luminance profile, the acquisition unit 16 detects a position whether the luminance is, for example, 50% of the maximum luminance and determines that the interface 31 is located at this detected position, and acquires the information indicating this position. In this determination, the relative value of the luminance with respect to the maximum luminance may be properly selected depending on characteristics of the two different fluids in contact with each other at the interface.

In the present embodiment, the acquisition unit 16 determines the position of the interface based on the luminance profile. Alternatively, to determine the position of the interface, the acquisition unit 16 may optically detect a change in refractive index appearing at the interface.

The second fluid 21 or the like that forms the interface may be a liquid, which may provide an advantage that it is easy to control the feeding of the liquid in the flow channel 13. To make it easy to detect the interface formed between two different fluids in contact with each other, a pigment such as a fluorescent pigment or the like may be added to one or both of the fluids. In this case, the acquisition unit 16 may detect fluorescence emitted from one or both of the fluids to acquire the information of the position of the interface 31. In this case, the system 100 may further include a light illumination unit (not illustrated) for use in the interface detection part. The light illumination unit may illustrate the fluid in the vicinity of the interface 31 with light thereby making the fluid emit light. This makes it possible to more clearly detect the interface 31 and thus to acquire more accurate information of the position of the interface 31.

To suppress diffusion of the two different fluids across the interface between them thereby to form the interface more clearly, for example, an aqueous solution may be used as one of fluids. In this case, the other fluid may be a liquid such as oil or a gas such as air which is not easily mixed together with water.

More specifically, the first fluid may be a DNA solution containing pigment intercalated into DNA, such as LCGreen™ available from Idaho Technology, Inc., SYBR™ available from Molecular Probes, Inc., or the like. The second fluid may be an aqueous solution containing pigment of a color different from the color of the pigment contained in the first fluid, such as Alexa Fluor™ available from Invitrogen, Inc. 647 or the like.

Next, a method of controlling the position of the first fluid 22 in the reaction part 131 is described below.

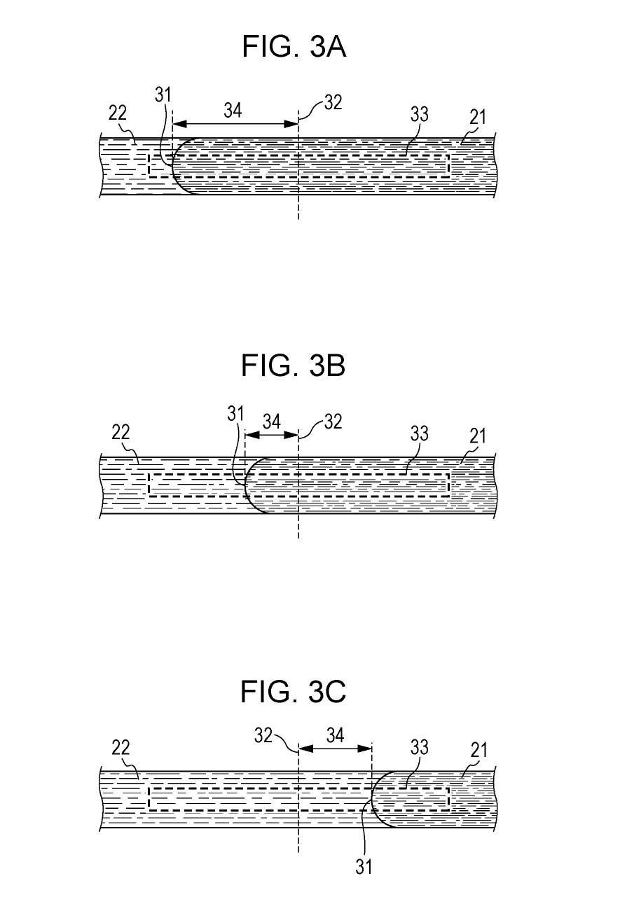

FIGS. 3A to 3C are diagrams schematically illustrating a method of controlling the position of the interface 31 in the flow channel 13. In FIGS. 3A to 3C, only a part of the flow channel 13 is illustrated in an enlarged manner to illustrate the interface detection part 132.

The two different fluids, and more specifically, the first fluid 22 existing in the reaction part 131 and the second fluid 21 exist continuously in the flow channel 13 and are in direct contact with each other such that the interface 31 is formed between them to be detected in the interface detection part 132. Therefore, by controlling the position of the interface 31 in the interface detection part 132, it is possible to control the position of the first fluid 22 in the reaction part 131. Thus, in the present embodiment, by controlling the position of the interface 31 in the interface detection part 132, the position of the first fluid 22 in the reaction part 131 is controlled.

As illustrated in FIG. 3A, the fluids (21 and 22) between which the interface 31 is to be formed are drawn into the downstream part of the flow channel 13 by using the liquid feed unit 17 until the interface 31 enters an interface detection region 33 which is a part of the interface detection part 132 to be subjected to the image analysis.

Next, the position control apparatus 12 performs image analysis using a processing unit (not illustrated) in the acquisition unit 16 or the computer 19 to acquire a difference 34 between the interface 31 and a target position 32 preset in the interface detection part 132 as illustrated in FIG. 3B. The computer 19 then determines a pressure value as a control parameter of the liquid feed unit 17 according to the acquired difference 34, and the fluids are drawn into the downstream part of the flow channel 13. More specifically, by reducing the pressure value of the liquid feed unit 17, it is possible to move the fluid in the flow channel 13 in a direction toward the discharge port 15.

In a case where the interface 31 has moved beyond the target position 32 as illustrated in FIG. 3C, the difference 34 is acquired in a similar manner to the above case, and the computer 19 determines the control parameter in terms of the pressure value of the liquid feed unit 17 according to the acquired difference 34, and the fluids are pushed in a direction opposite to the case in FIG. 3B, that is, in an upstream direction in the flow channel 13. More specifically, by increasing the pressure value of the liquid feed unit 17, the fluid in the flow channel 13 is moved in a direction toward the injection port 14.

In the present embodiment, as described above, the target position 32 is set, and the position of the interface 31 is controlled such that the position of the interface 31 is moved to be closer to the target position 32. By controlling the position of the interface 31 in the above-described manner, it is possible to maintain the position of the interface 31 in the vicinity of the target position 32. Furthermore, the position of the first fluid 22 in the reaction part 131 is controlled so as to be maintained in the vicinity of a predetermined position. Thus, it is possible to allow the first fluid 22 to be subjected to the reaction in the reaction part 131 under a predetermined condition.

In the present embodiment, the position of the interface 31 is controlled such that the position of the interface 31 is moved to be closer to the target position 32 set in the interface detection part 132. However, alternatively, a target range may be set in the vicinity of the target position 32, and the position of the interface 31 may be controlled such that the position of the interface 31 is maintained within the target range. This method also allows it to achieve similar advantageous effects to those achieved in the case where the position of the interface 31 is controlled such that it is moved to be closer to the target position 32.

When the first fluid 22 is subjected to the reaction in the reaction part 131, the reaction may be enhanced by heating the first fluid 22 using a not-illustrated heater or the like or by irradiating the first fluid 22 with an electromagnetic wave. In many cases, the reaction of the first fluid 22 causes an increase in temperature of the first fluid 22, which may in turn cause a change in the volume of the first fluid 22. More specifically, for example, when the temperature of the first fluid 22 increases, the volume of the first fluid 22 expands.

As described above, the two different fluids forming the interface 31 to be detected in the interface detection part 132, that is, the first fluid 22 in the reaction part 131 and the second fluid exist continuously in the flow channel 13. Therefore, when the volume of the first fluid 22 in the reaction part 131 expands or contracts, a corresponding change in the position of the interface 31 occurs. For example, in the present embodiment, when the volume of the first fluid 22 in the reaction part 131 expands, the interface 31 accordingly moves in the direction to the downstream.

Therefore, in the controlling of the position of the first fluid 22 in the reaction part 131, it may be advantageous to perform the control taking into account the change in the volume of the first fluid 22. More specifically, for example, the control may be performed as follows.

When a change of ΔT (° C.) occurs in the temperature of the first fluid 22 having a volume of V₀ (μm³), the volume V (μm³) of the first fluid 22 after the change in the volume is given by formula (1) shown below where β denotes a volume expansion coefficient (1/° C.) of the first fluid 22.

V=V₀(1+βΔT) (1)

Note that when the first fluid 22 is water, the volume expansion coefficient β is 2.1×10⁻⁴ (1/° C.).

Based on formula (1) using the volume of the flow channel 13, it is possible to derive a relationship between the change in the temperature of the first fluid 22 and the change in the position of the interface 31. Furthermore, based on this relationship, the position of the interface 31 and the position of the first fluid 22 are controlled using the method described above while changing the target position 32 such that the change in the position of the interface 31 is cancelled thereby reducing the influence of the change in temperate caused by the reaction of the first fluid 22 in the reaction part 131, which makes it possible to more accurately control the position of the first fluid 22 in the reaction part 131.

In the case where a target range is set in the vicinity of the target position 32 and the position of the interface 31 is controlled such that the position of the interface 31 is maintained within the target range, the control may be performed while changing the width of the target range or the center position of the target range such that the effects described above are achieved.

Next, the shape of the flow channel 13 in the interface detection part 132 is described below.

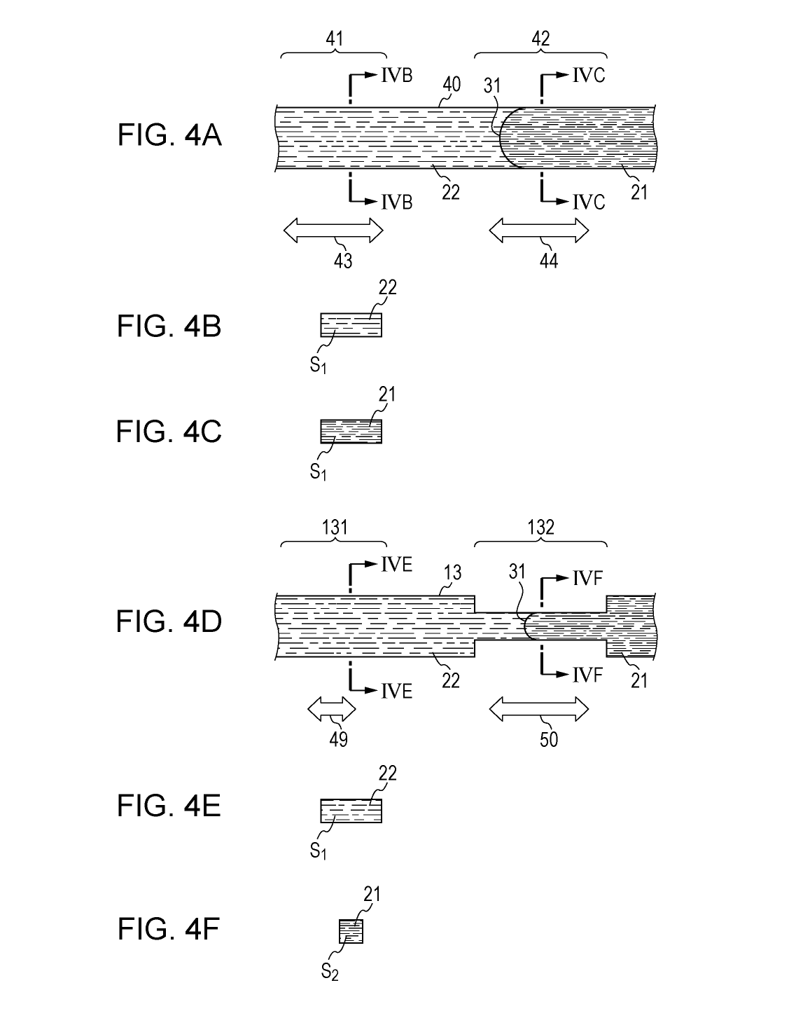

FIGS. 4A to 4F schematically illustrate a relationship between the change in the position of the interface 31 in the interface detection part 132 and the change in the position of the fluid in the reaction part 131. It is assumed here by way of example that one of two fluids forming the interface 31 is the first fluid 22 to be subjected to the reaction in the reaction part 131, and the second fluid 21 is the other one of the two fluids. FIG. 4A schematically illustrates a change in position of the interface 31 in an interface detection part 42 of a conventional micro flow channel 40 (hereinafter also referred to simply as a flow channel 40), and a corresponding change in position of a first fluid 22 in a reaction part 41. FIG. 4D schematically illustrates a change in position of the interface 31 in the interface detection part 132 of the flow channel 13 according to the present embodiment, and a corresponding change in position of the first fluid 22 in the reaction part 131.

In FIGS. 4A and 4D, the flow channel (the flow channel 40 or 13) is seen from the above. FIGS. 4B and 4C are cross-sectional views taken perpendicularly to the channel direction along lines IVB-IVB and IVC-IVC respectively of the flow channel 40 in FIG. 4A. FIGS. 4E and 4F are cross-sectional views taken perpendicularly to the channel direction along lines IVE-IVE and IVF-IVF respectively of the flow channel 13 in FIG. 4D. In these figures, the cross sections IVB-IVB and IVE-IVE are in the flow channels 40 or 13 in the reaction parts 41 or 131, and the cross sections IVC-IVC and IVF-IVF are in the flow channels 40 or 13 in the interface detection parts 42 or 132.

As may be seen from FIGS. 4B, 4C, 4E, and 4F, the flow channels 40 and 13 illustrated in FIGS. 4A and 4D respectively both have a shape of a rectangular parallelepiped. Thus, the depth of each of the flow channels 40 and 13 as measured in the interface detection part 42 or 132 is equal to the depth of each of the flow channels 40 and 13 as measured in the reaction part 41 or 131. Note that the depth of each of the flow channels 40 and 13 illustrated in FIGS. 4A and 4D respectively is constant in the direction along the flow channel.

In the flow channel 40 illustrated in FIG. 4A, the width in the reaction part 41 is the same as that in the interface detection part 42. Therefore, as may be seen from FIGS. 4B and 4C, the area of the cross section, in the reaction part 41, taken perpendicularly to the channel direction of the flow channel 40 is same as the area of the cross section, in the interface detection part 42, taken perpendicularly to the channel direction of the flow channel 40. Therefore, the position change 43 of the fluid in the direction along the flow channel in the reaction part 41 is equal to the position change 44 of the fluid and the interface 31 in the direction along the flow channel in the interface detection part 42.

On the other hand, in the flow channel 13 in the system 100 according to the present embodiment, as illustrated in FIG. 4D, the width of the flow channel 13 is smaller in the interface detection part 132 than in the reaction part 131. Therefore, as my be seen from FIGS. 4E and 4F, the area S₂ of the cross section perpendicular to the direction along the flow channel 13 in the interface detection part 47 is smaller than the area S₁ of the cross section perpendicular to the direction along the flow channel 13 in the reaction part 131. Therefore, the position change 49 of the fluid in the direction along the flow channel in the reaction part 131 is smaller than the position change 50 of the fluid or the interface 31 in the direction along the flow channel in the interface detection part 132. For example, when the width of the flow channel 13 in the interface detection part 132 is set to be one-half the width of the flow channel 13 in the reaction part 131, the position change 49 of the fluid in the direction along the flow channel occurring in the reaction part 131 becomes one-half the position change 50 of the fluid or the interface 31 in the direction along the flow channel occurring in the interface detection part 132. In other words, by forming the flow channel 13 in the system 100 in the above-described manner according to the present embodiments, the position change 49 of the fluid in the direction along the flow channel occurring in the reaction part 131 is observed in an enlarged manner in the interface detection part 47.

The accuracy of detecting the position of the interface 31 in the interface detection part 42 or 132 is limited by the resolution of a sensor used as the acquisition unit 16. In the case illustrated in FIG. 4A, the position change 43 of the fluid in the direction along the flow channel occurring in the reaction part 41 is equal to the position change 44 of the fluid in the direction along the flow channel occurring in the interface detection part 42. Therefore, the accuracy of controlling the position of the fluid in the flow channel 40 in the reaction part 41 is equal to the accuracy in detecting the position of the interface in the interface detection part 42.

On the other hand, in the case illustrated in FIG. 4D, the position change 49 of the fluid in the direction along the flow channel in the reaction part 131 is one-half the position change 50 of the fluid in the direction along the flow channel in the interface detection part 132. The minimum controllable change in position in controlling the position of the fluid in the flow channel 13 in the reaction part 131 may be one-half the resolution of the sensor used as the acquisition unit 16. That is, the accuracy of controlling the position of the fluid in the flow channel 13 in the reaction part 131 may be twice higher than the accuracy of detecting the position of the interface in the interface detection part 132. Therefore, use of the structure shown as an example in the FIG. 4D makes it possible to improve the accuracy of controlling the position of the fluid in the flow channel 13 even when the resolution of the sensor used as the acquisition unit 16 is low.

Note that the resolution of the sensor used as the acquisition unit 16 and the width of the flow channel 13 in the interface detection part 132 may be appropriately selected within ranges that allow the present embodiment to be executed.

In the present embodiment, it is assumed that the depth of the flow channel 13 is constant in the direction along the flow channel. While maintaining the above-described depth constant, the width of the flow channel 13 in the interface detection part 132 is set to be smaller than in the reaction part 131 thereby achieving a reduction in change in the position of the fluid in the reaction part 131. In this configuration, it may be advantageous to form the above-described depth so as to be nearly constant. Preferably, the above-described depth may be set such that the ratio of the minimum value thereof to the maximum value is equal to greater than 80%, and more preferably equal to or greater than 90%.

The advantageous effects of the present embodiment may be achieved by setting the area of the cross section perpendicular to the flow channel of the flow channel 13 in the interface detection part 132 to be smaller than the area of the cross section perpendicular to the direction along the flow channel 13 in the reaction part 131. For example, without changing the width of the flow channel 13, the depth of the flow channel 13 in the interface detection part 132 may be set to be smaller than the depth of the flow channel 13 in the reaction part 131 thereby achieving a reduction in the change in position of the fluid in the reaction part 131. However, in the case where the position of the interface 31 is detected by detecting light from the fluid, if the depth of the flow channel 13 is set to be too large, a reduction may occur in detectable amount of light, which may result in a reduction in signal strength and thus a reduction in signal-to-noise ratio. For the above reason, it may be more advantageous to reduce the width of the flow channel 13 in the interface detection part 132 while maintaining the depth of the flow channel 13 at not too large a value.

Although in the present embodiment, the flow channel 13 has a shape of a rectangular parallelepiped, there is no particular restriction on the shape of the flow channel 13. That is, the shape or the size of the cross section perpendicular to the direction of the flow channel 13 in the reaction part 131 may not be constant in the direction along the flow channel 13, and the shape or the size of the cross section perpendicular to the direction of the flow channel 13 in the interface detection part 132 may not be constant in the direction along the flow channel 13. In this case, the average area of the cross section perpendicular to the direction of the flow channel 13 in the interface detection part 132 may be set to be smaller than the average area of the cross section perpendicular to the direction of the flow channel 13 in the reaction part 131 such that a reduction is achieved in the change in position of the fluid in the reaction part 131. Alternatively, the depth of the flow channel 13 may be set to be substantially constant in the direction along the flow channel 13, the average width of the flow channel 13 in the interface detection part 132 may be set to be smaller than the average width of the flow channel 13 in the reaction part 131 such that a reduction is achieved in the change in position of the fluid in the reaction part 131.

An approximate average value of the area size of the cross section perpendicular to the direction of the flow channel 13 may be measured by producing a plurality of cross sections of the flow channel 13, measuring the area sizes thereof, and calculating the average value thereof. Alternatively, the average value may be calculated from a drawing or CAD data of a design of the device 11.

Although the above description is for the case where the shape or the size of the cross section of the flow channel 13 is not constant in the direction along the flow channel 13 in the reaction part 131 or the interface detection part 132, similar advantageous effects may also be obtained in a case where the shape or the size of the cross section of the flow channel 13 may be constant in the direction along the flow channel 13. That is, in the case where the shape or the size of the cross section of the flow channel 13 is constant in the direction along the flow channel 13, similar advantageous effects may be obtained by forming the flow channel 13 such that the average cross section area in the interface detection part 132 is smaller than the average cross section area in the reaction part 131. In the case where the flow channel 13 has, for example, a rectangular parallelepiped shape in cross section, the shape and the size of the cross section of the flow channel 13 in the direction along the flow channel 13 are constant, and thus the average cross section area may be obtained by forming one cross section of the flow channel 13 and measuring the size thereof.

### EXAMPLES

The present invention is described in further detail below with reference to specific examples. Note that examples described below are only for illustration of the invention but not limitation.

In the examples described below, a thermal melting point (Tm) of DNA was determined using a thermal melting method while controlling the position of the interface between fluids in the interface detection part, and it was confirmed that advantageous effects were achieved.

### Comparative Example

Before examples of the invention are described, a comparative example is described as to a fluid control system 500 including a microfluidic device 501 including a flow channel 508 whose average cross-sectional area size is equal in an interface detection part 542 and in a reaction part 541.

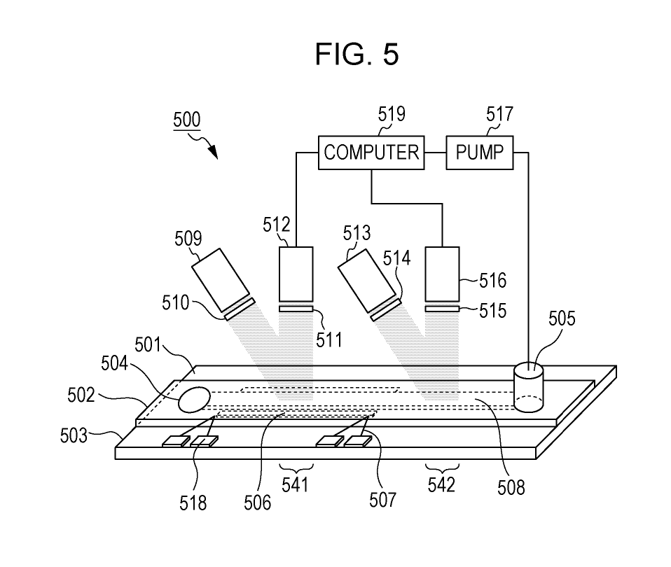

FIG. 5 is a diagram illustrating a configuration of the fluid control system 500 of the comparative example.

The microfluidic device 501 was produced by bonding two glass substrates 502 and 503 to each other. Of the two glass substrates, the glass substrate 502 is an upper substrate with a size of 10 mm in width, 30 mm in length, and 0.25 mm in thickness, while the glass substrate 503 is a lower substrate with a size of 15 mm in width, 30 mm in length, and 0.5 mm in thickness.

An injection port 504 and a discharge port 505 were produced in the upper substrate 502 by drilling holes therein. Furthermore, the micro flow channel 508 extending from the center of the injection port 504 to the center of the discharge port 505 and having a size of 20 mm in length, 20 μm in depth, and 180 μm in width was produced by dry etching on the upper substrate 502.

A platinum film with a thickness of about 100 nm was formed on the lower substrate 503 by sputtering. The platinum film was patterned into a shape of resistor element 506 with a size of 8 mm in length and 300 μm in width by a photolithography process thereby forming a resistor element 506. Subsequently, a titanium film, a gold film, and a titanium films were formed in this order on the resistor element 506 by successively performing sputtering to form a titanium-gold-titanium multilayer film with a total thickness of 300 nm. The titanium-gold-titanium multilayer film was then patterned by a photolithography process so as to from electrodes 507 on the resistor element 506, and four terminals 518 for use in measuring a resistance value using a four terminal method were formed. After the resistor element 506 and the electrodes 507 were formed on the lower substrate 503, a silicon oxide film with a thickness of about 1 μm for providing insulation from the micro flow channel 508 was formed on the lower substrate 503 by a chemical vapor deposition (CVD) process.

Thereafter, the surface of the upper substrate 502 and the surface of the lower substrate 503 were irradiated with plasma thereby reforming the surfaces. The upper substrate 502 and the lower substrate 503 were then bonded together to form the microfluidic device 501.

Next, the configuration of the fluid control system 500 is described below.

To detect an interface (not illustrated) formed between two different fluids (not illustrated) in contact with each other in the interface detection part 542, a fluid (not illustrated) in the interface detection part 542 was illuminated with light using a light emitting diode (LED) 513 serving as a light illumination unit for use in the interface detection part. The light emitted from the LED 513 was passed through a filter 514 to extract light having wavelengths in only a particular wavelength range corresponding to a fluorescent pigment in the second fluid (not illustrated). After being passed through the filter 514, the light struck the fluid (not illustrated) in the micro flow channel 508 in the interface detection part 542 to excite the fluorescent pigment in the fluid thereby making the fluorescent pigment emit light. The light from the fluorescent pigment was passed through a filter 515, and sensed and converted to a signal by a camera 516 serving as a position information acquisition unit. An aqueous solution containing Alexa Fluor™ 647 which was a fluorescent pigment capable of emitting fluorescent light with red color was used by way of example as the second fluid (not illustrated), and filters allowing only red light to pass through were used as the filter 514 and the filter 515. The acquired signal was sent to a computer 519 to produce image data based on the acquired signal.

To measure the fluorescence intensity in the reaction part 541, the fluid (not illustrated) in the reaction part 541 was illuminated with light using an LED 509 serving as a light illumination unit for use in the reaction part. In this process, the light emitted from the LED 509 was passed through a filter 510 to extract light having wavelengths in only a particular wavelength range corresponding to the fluorescent pigment in the first fluid (not illustrated). After being passed through the filter 510, the light struck the fluid (not illustrated) in the micro flow channel 508 in the reaction part 541 to excite the fluorescent pigment in the fluid thereby making the fluorescent pigment emit fluorescent light. The light from the fluorescent pigment was sent via a filter 511 to a camera 512 serving as a reaction detection unit and sensed and converted to a signal by the camera 512. An aqueous solution containing LCGreen™ which was a fluorescent pigment capable of emitting fluorescent light with green color was used by way of example as the first fluid, and filters allowing only green light to pass through were used as the filter 510 and the filter 511. The acquired signal was sent to a computer 519 to produce image data based on the acquired signal. The camera 512 and camera 516 used both had a resolution of 80 μm.

To produce the image data, an image including the reaction part 541 and an image including the interface detection part 542 were captured simultaneously by the camera 512 and the camera 516 respectively at intervals of time of one second. In the micro flow channel 508, the interface detection part 542 was set in a region having a length of 800 μm (corresponding to 10 pixels) as measured in the direction along the flow channel and centered at a potion apart by 17.5 mm from the injection port 504. The reaction part 541 was set in a region with a length of 240 μm (corresponding to 3 pixels) as measured in the direction along the flow channel and centered at the center of the resistor element 506.

Using the fluid control system 500 described above, Tm of DNA was measured. A measurement method and a measurement result are described below.

First, the second fluid different from the first fluid to be subjected to the reaction was injected via the injection port 504 such that the inside of the flow channel 508 is filled with the second fluid. As for the second fluid, an aqueous solution containing Alexa Fluor™ 647 which was a fluorescent pigment capable of emitting fluorescent light with red color in response to illumination with excitation light was used.

Next, following the second fluid, the first fluid is injected via the injection port 504 and the second fluid and the first fluid were drawn by a pump 517 connected to the discharge port 505. The position of the first fluid was controlled using the method of determining the position of the interface and the method of controlling the position of the interface described above. As for the first fluid in the present comparative example, a DNA solution was produced so as to have a designed value of 80° C. for Tm and LCGreen™ which was a fluorescent pigment capable of emitting fluorescent light with green color was added to the DNA solution, and a resultant solution was used as the first fluid.

A change, in the direction along the flow channel, of the position of the interface (not shown) formed between the second fluid and the first fluid in contact with each other was measured in the interface detection part 542 while heating the first fluid in the reaction part 541. The standard deviation of measured values of the change in the position of the interface that occurred during a period of one minute after the control was started to maintain the interface at a target position set in the interface detection part 542 was 100 μm. This value of the standard deviation was nearly equal to a value estimated to be determined by the resolution of the cameras.

A temperature distribution in the reaction part 541 was measured using an infrared microscope, and the temperature distribution observed in the reaction part 541 was 1.0° C./mm in the forward direction of the fluid. This temperature distribution was caused by a presence of a part, such as the interface detection part 542, in the downstream from the reaction part 541 that was not heated by the heater (the resistor element 506). That is, the fluid detected in the reaction part 541 is subjected to a temperature distribution over a length of 240 μm in the direction along the flow channel in the reaction part 541 plus a length of 100 μm caused by the change in position, and thus a total of 340 μm. Therefore, the fluid detected in the reaction part 541 was estimated to have a temperature distribution of 0.34° C.

The temperature of the reaction part 541 was increased from 60° C. to 90° C. at a rate of 1° C./second thereby thermally melting DNA, and the Tm was measured based on the relationship between the temperature and the fluorescence intensity. Tm was measured 20 times successively, and the standard deviation of measured value was calculated. The result was 0.20° C.

### First Example

Next, a first example of the invention is described below as to a fluid control system 600 including a microfluidic device 601 having a flow channel 608 formed such that the width thereof is narrowed in an interface detection part 632.

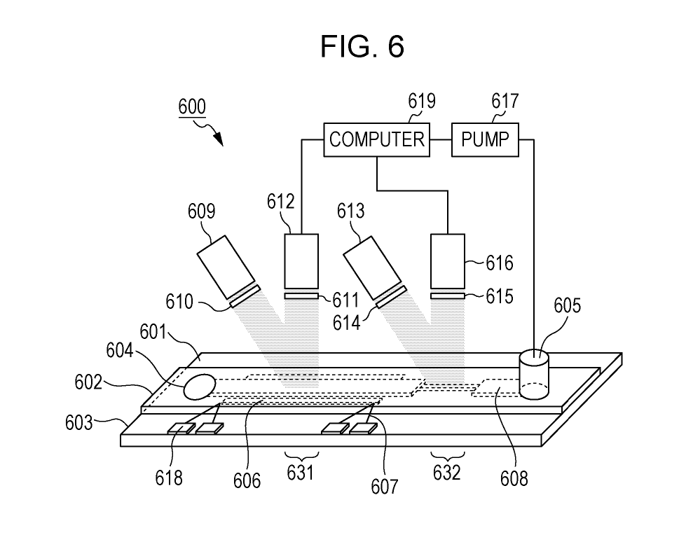

FIG. 6 is a diagram illustrating a configuration of the fluid control system 600 of the first example.

The method of producing the microfluidic device 601 and the material thereof are similar to those for the microfluidic device 501 of the comparative example except that the flow channel on the upper substrate 602 was formed as follows. First, a flow channel with a depth of 20 μm and a width of 180 μm was formed such that it extends from the center of an injection port 604 toward the discharge port 605 over a length of 15 mm. Following a downstream end of the flow channel described above, a flow channel with a length of 5 mm, a depth of 20 μm, and a small width of 100 μm was formed in a region functioning as an interface detection part 632. Furthermore, a flow channel with a length of 5 mm, a depth of 20 μm, and a width of 180 μm was formed so as to extend from a downstream end of the narrow flow channel described above to the center of a discharge port 605.

In the present example, as described above, the depth of the flow channel 608 was set to be 20 μm in both the interface detection part 632 and the reaction part 631. On the other hand, the width of the flow channel 608 is set to be 100 μm in the interface detection part 632 and 180 μm in the reaction part 631. That is, the size of the cross section area perpendicular to the direction along the flow channel 608 in the interface detection part 632 was set to be smaller than in the reaction part 631. Furthermore, in the present example, the flow channel 608 has a shape of a rectangular parallelepiped both in the reaction part 631 and the interface detection part 632. Thus, the average value of the cross section area perpendicular to the direction along the flow channel 608 in the interface detection part 632 was smaller than that in the reaction part 631.

The configuration of the fluid control system 600 was similar to that of the fluid control system 500 of the comparative example.

Using the fluid control system 600 of the present example described above, Tm of DNA was measured. A measurement method and a measurement result are described below.

First, a second fluid (not illustrated) different from a first fluid to be subjected to reaction is injected via the injection port 604 such that the inside of the flow channel 608 is filled with the second fluid. In the present example, as for the second fluid (not illustrated), an aqueous solution containing Alexa Fluor™ 647 which was a fluorescent pigment capable of emitting fluorescent light with red color in response to illumination with excitation light was used.

Next, following the second fluid, the first fluid (not illustrated) is injected via the injection port 604 and the second fluid and the first fluid were drawn by a pump 608 connected to the discharge port 605. The position of the first fluid was controlled using the method of determining the position of the interface and the method of controlling the position of the interface described above. In the present example, as for the first fluid, a DNA solution was produce so as to be desired to have Tm of 80° C. and LCGreen™ which was a fluorescent pigment capable of emitting fluorescent light with green color was added to the DNA solution, and a resultant solution was used as the first fluid.

A change, in the direction along the flow channel, of the position of the interface (not shown) formed between the second fluid and the first fluid in contact with each other was measured in the interface detection part 632 while heating the first fluid (not illustrated) in the reaction part 631. The standard deviation of measured values of the change in the position of the interface that occurred during a period of one minute after the control was started to maintain the interface at a target position set in the interface detection part 632 was 100 μm. This value of the standard deviation was nearly equal to a value estimated to be determined by the resolution of the cameras as with the comparative example.

Both in the present example and the comparative example, the width of the flow channel 608 or 508 in the reaction part 631 or 541 was the same (180 μm). On the other hand, in the present example, the width of the flow channel 608 in the interface detection part 632 was set to 100 μm smaller than the width (180 μm) of the flow channel 508 in the interface detection part 542 in the comparative example. Therefore, in a case where the accuracy of detecting the position of the interface in the interface detection part 632 is, for example, 100 μm, the accuracy of controlling the position of the fluid in the reaction part 631 is given by 100 μm times 100/180, and thus about 56 μm. That is, the fluid detected in the reaction part 631 is subjected to a temperature distribution over a length of 240 μm in the direction along the flow channel in the reaction part 631 plus a length of 56 μm caused by the change in position, and thus a total of 296 μm. Therefore, the fluid detected in the reaction part 631 was estimated to have a temperature distribution of 0.30° C., which was smaller than the temperature distribution of 0.34° C. in the comparative example.

The temperature of the reaction part 631 was increased from 60° C. to 90° C. at a rate of 1° C./second thereby thermally melting DNA, and the Tm was measured based on the relationship between the temperature and the fluorescence intensity. Tm was measured 20 times successively, and the standard deviation of measured value was calculated. The result was 0.170° C., which was smaller than that obtained in the comparative example.

The above-described reduction in the temperature distribution of the fluid detected in the reaction part 631 was achieved by the improvement in the accuracy of controlling the position of the first fluid in the micro flow channel 608 in the reaction part 631. That is, use of the fluid control system 600 formed in the above-described manner according to the present example made it possible to improve the accuracy of controlling the position of the first fluid in the micro flow channel 608 in the reaction part 631.

### Second Example

In a second example of a fluid control system 700 described below, detection in the reaction part 631 and detection in the interface detection part 632 were both performed using a single detection unit 716. In the present example, using the single detection unit 716, an image was captured from a region including both the reaction part 631 and the interface detection part 632, and the obtained image was analyzed to acquire position information as to the interface (not illustrated) in the interface detection part 632 and to detect reaction in the reaction part 631.

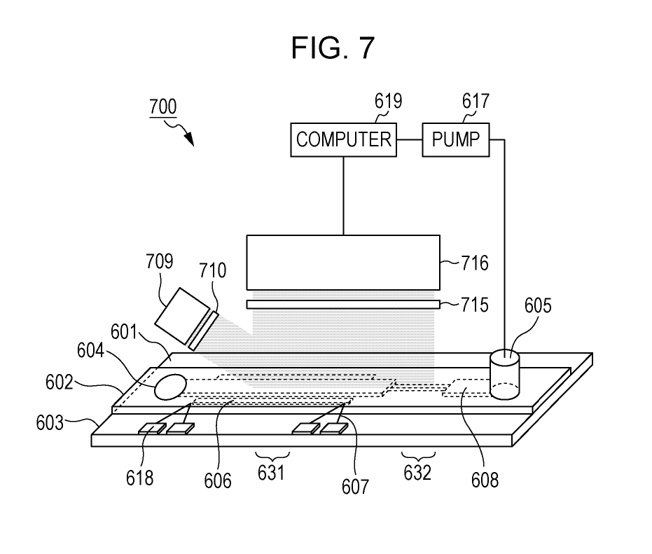

FIG. 7 is a diagram illustrating a configuration of the fluid control system 700 of the second example.

The structure of the microfluidic device 601 is similar to that of the microfluidic device 601 of the first example.

Next, the configuration of a position control apparatus having a feature of the present example is described below.

To acquire the image of the reaction part 631 and the interface detection part 632, parallel light emitted from an LED 709 serving as a light illumination unit was passed through a filter 710 and the fluid (not illustrated) in the micro flow channel 608 in the reaction part 631 and the interface detection part 632 was illuminated with the light emerging from the filter 710 thereby exciting the fluorescent pigment in the fluid to make the fluorescent pigment emit light. The light from the fluorescent pigment was passed through a filter 715, and sensed and converted to a signal by a camera 716. The acquired signal was sent to a computer 619 to produce image data based on the acquired signal. The camera 716 used had a resolution of 80 μm.

Using the fluid control system 700 of the present example described above, Tm of DNA was measured. A measurement method and a measurement result are described below.

First, a second fluid (not illustrated) different from a first fluid to be subjected to reaction is injected via the injection port 604 such that the inside of the flow channel 608 is filled with the second fluid. As for the second fluid, an aqueous solution containing Alexa Fluor™ 647 which was a fluorescent pigment capable of emitting fluorescent light with red color in response to illumination with excitation light was used.

Next, following the second fluid, the first fluid (not illustrated) is injected via the injection port 604 and the second fluid and the first fluid were drawn by a pump 617 connected to the discharge port 605. The position of the first fluid was controlled using the method of determining the position of the interface and the method of controlling the position of the interface described above. As for the first fluid in the present example, a DNA solution was produce so as to be desired to have Tm of 80° C. and LCGreen™ which was a fluorescent pigment capable of emitting fluorescent light with green color was added to the DNA solution, and a resultant solution was used as the first fluid.

A change, in the direction along the flow channel, of the position of the interface (not shown) formed between the second fluid and the first fluid in contact with each other was measured in the interface detection part 542. The standard deviation of values measured during a period of one minute after the control was started to maintain the interface at a target position was 100 μm. This value of the standard deviation was nearly equal to a value estimated to be determined by the resolution of the cameras as with the comparative example.

The temperature of the reaction part was increased from 60° C. to 90° C. at a rate of 1° C./second thereby thermally melting DNA, and the Tm was measured based on the relationship between the temperature and the fluorescence intensity. Tm was measured 20 times successively, and the standard deviation of measured values was calculated. The calculated standard deviation was 0.17° C., which was, as in the first example, smaller than that obtained in the comparative example.

The above-described reduction in the standard deviation was achieved by the improvement in the accuracy of the position of the first fluid in the micro flow channel 608 in the reaction part 631 and thus a reduction in temperature distribution in the reaction part 631 was achieved. That is, use of the fluid control system 700 formed in the above-described manner according to the present example made it possible to improve the accuracy of controlling the position of the first fluid in the micro flow channel 632 in the reaction part 631.

In the present example, because the region including both the reaction part 631 and the interface detection part 632 were detected using the single camera 716, it was possible to perform the measurement in a simple manner compared with the case where two different cameras 612 and 616 were used to detect the reaction part 631 and the interface detection part 632 respective according to the first example.

### Third Example

Next, a description is given below as to a third example in which the position of the first fluid in the micro flow channel is controlled while changing the target position of the position of the interface in the interface detection part based on the predicted change in the volume of the fluid in the micro flow channel caused by a change in temperature.

The configuration of the fluid control system of the third example is similar to that of the fluid control system 700 of the second example. A method of controlling the position of the interface in the interface detection part 632 during the thermal analysis is described below for a case in which a thermal melting method is employed.

In the present example, volume expansion in the reaction part 631 may occur in a region with a length of 8 mm located directly above the resistor element 606, and this regions has a value of 2.9×10⁷ μm³. In the present example, it is assumed by way of example that the fluid is an aqueous solution. Therefore, if the expansion is calculated using the volume expansion coefficient of water, then the calculation indicates that an increase of temperature of the fluid in the flow channel 608 by 1° C. results in an expansion of the flow channel 608 by 1.6 μm in the direction along the flow channel 608. That is, in the present example, an increase of temperature by 1° C. causes the fluid in the flow channel 608 to expand by 0.8 μm in both upstream and downstream directions. Therefore, in a case where the temperature of the reaction part 631 is increased at a rate of, for example, 1° C./second, the interface (not illustrated) in the interface detection part 632 is pushed out in the downstream direction at a speed of 0.8 μm/second. This volume change caused by the temperature change is a factor that may cause a reduction in accuracy of controlling the position of the fluid.

In view of the above, in the present example, the target position in controlling the position of the interface in the interface detection part 632 was changed depending on the change in temperature of the reaction part 631 such that the influence of the change in the volume of the fluid caused by the change in temperature of the fluid is cancelled by the change of the target position. More specifically, the position of the interface was controlled while moving the target position in the downstream direction by at a speed of 0.8 μm/second in response to a change in temperature of the reaction part at a rate of 1° C./second.

A change, in the direction along the flow channel, of the position of the interface (not shown) formed between the second fluid and the first fluid in contact with each other was measured in the interface detection part 632. The accuracy of the position measured during a period of one minute after the control was started to maintain the interface at the target position was 90 μm. That is, in the present example, it was possible to reduce the change of the position of the interface in the direction along the flow channel compared with those in the comparative example, the first example, and the second example.

Using the control method described above, DNA was thermally melted and Tm was measured. Tm was measured 20 times successively, and the standard deviation thereof was calculated. The calculated standard deviation was 0.15° C.

As described above, by further controlling the target position depending on the change in temperature of the reaction part 631 using the fluid control system 700 according to the second example, an increase in accuracy of the position of the first fluid in the reaction part 631 was achieved. As a result, the temperature distribution of the fluid detected in the reaction part 631 was reduced, and the measurement accuracy of Tm was improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-097769 filed May 9, 2014, which is hereby incorporated by reference herein in its entirety.

What is claimed is:

1. A fluid control system comprising:
a fluid device including a flow channel having a reaction part in which a first fluid is to be subjected to a reaction; and
a position control apparatus,
wherein the position control apparatus includes a position information acquisition unit configured to acquire information of a position, in the flow channel, of an interface formed between the first fluid and a second fluid in contact with each other in the flow channel or between the second fluid and a third fluid in contact with each other in the flow channel,
the position control apparatus controls the position of the first fluid in the flow channel based on the information of the position acquired by the position information acquisition unit, and
the information of the position by the position information acquisition unit is acquired in an interface detection part that is located at an upstream or downstream position in the direction along the flow channel with respect to the reaction part and that has a smaller average area of the cross section perpendicular to the direction along the flow channel than the average area of the cross section perpendicular to the direction along the flow channel in the reaction part.

2. The fluid control system according to claim 1, wherein the flow channel has a substantially constant depth in the reaction part and also in the interface detection part.

3. The fluid control system according to claim 2, wherein an average width value of the flow channel in the interface detection part is smaller than an average width value of the flow channel in the reaction part.

4. The fluid control system according to claim 1, wherein the position control apparatus controls the position of the first fluid in the reaction part such that the position of the interface becomes closer to a target position set in the interface detection part.

5. The fluid control system according to claim 1, wherein the position control apparatus controls the position of the first fluid in the reaction part such that the position of the interface remains within a target range set in the interface detection part.

6. The fluid control system according to claim 4, wherein the position control apparatus changes the target position depending on a change in temperature of the first fluid.

7. The fluid control system according to claim 4, wherein the position control apparatus changes a width or a position of the target range depending on a change in temperature of the first fluid.

8. The fluid control system according to claim 1, wherein the position information acquisition unit acquires the information of the position of the interface by detecting light from the first fluid, or the second fluid, or the third fluid forming the interface.

9. The fluid control system according to claim 8, wherein the position information acquisition unit acquires image data by detecting light from a region including the interface detection part at least one-dimensionally in direction along the flow channel, and acquires the information of the position of the interface by analyzing the image data.

10. The fluid control system according to claim 9, wherein the position information acquisition unit is a unit that two-dimensionally detects light from a region including the interface detection part.

11. The fluid control system according to claim 8, wherein the position information acquisition unit detects light from a region including the interface detection part and the reaction part.

12. The fluid control system according to claim 11, wherein the position information acquisition unit detects the position of the interface and detects light in the reaction part.

13. The fluid control system according to claim 1, further comprising a light illumination unit,
wherein the light illumination unit illuminates the first fluid, or the second fluid, or the third fluid with light,
and wherein the position information acquisition unit acquires the information of the position of the interface by detecting fluorescence from the first fluid, or the second fluid, or the third fluid.

14. A fluid device for use in the fluid control system according to claim 1.

15. A method of controlling a fluid in a fluid device including at least one flow channel including a reaction part in which a first fluid is to be subjected to a reaction, the method, to control a position of the first fluid in the flow channel, comprising:
detecting an interface formed between two different fluids in contact with each other in an interface detection part that is located at an upstream or downstream position in the direction along the flow channel with respect to the reaction part and that has a smaller average area of the cross section perpendicular to the direction along the flow channel than an average area of the cross section perpendicular to the direction along the flow channel in the reaction part; and
controlling a position of the first fluid in the reaction part based on the information of the detected position of the interface.
